(19) United States
(12) Patent Application Publication
(10) Pub. No.: US 2010/0295448 A1
(43) Pub. Date: Nov. 25, 2010

(54) VEHICLE DISCHARGE LAMP

(75) Inventors: Michio TAKAGAKI, Shizuoka (JP); Akira HOMMA, Shizuoka (JP); Yoshiro ITO, Shizuoka (JP); Yoshihiro MOCHIZUKI, Shizuoka (JP); Masato HARAZAKI, Shizuoka (JP)

Correspondence Address: SUGHRUE-265550, 2100 PENNSYLVANIA AVE. NW, WASHINGTON, DC, 20037-3213, US

(73) Assignee: KOITO MANUFACTURING CO., LTD., Tokyo (JP)

(21) Appl. No.: 12/782,069

(22) Filed: May 18, 2010

(30) Foreign Application Priority Data
May 20, 2009 (JP) P.2009-122318

(51) Int. Cl. H01J 61/36

(52) U.S. Cl. 313/623

(57) ABSTRACT

A vehicle discharge lamp is provided with an outer tube, an arc tube disposed within the outer tube, and a pair of electrodes disposed within the arc tube. The arc tube includes a light emitting portion, and a pair of pinch seal portions. Molybdenum foils are sealed in the respective pinch seal portions. Each of the electrodes includes a sealed portion sealed within the pinch seal portion, a projecting portion projecting into the light emitting portion, and a welding portion welded to the molybdenum foil. A concavo-convex part is formed on the sealed portion.

### BACKGROUND OF THE INVENTION

1. Field of the Invention

The present invention relates to a discharge lamp for use in a vehicle. Specifically, the invention relates to a vehicle discharge lamp, in which a concavo-convex part including a concave portion and a convex portion is formed on a portion of an electrode sealed in a pinch seal portion of an arc tube, to thereby restrict a generation of a crack and thus prevent a generation of a leakage at the electrode.

2. Background Art

As a headlamp for use in an vehicle, for example, there are known a headlamp of a type using an incandescent lamp (an incandescent bulb) or a halogen lamp (a halogen bulb) as its light source, a headlamp of a type using a discharge lamp (a discharge bulb) as its light source, or a headlamp of a type using a light emitting diode (LED) as its light source.

Referring to the vehicle headlamp using the discharge lamp as its light source, since the discharge lamp is larger in an amount of light and is higher in a radiance than the incandescent lamp, halogen lamp and light emitting diode, the vehicle headlamp using the discharge lamp has an advantage that it can realize a headlamp having a large light amount.

The discharge lamp has a double tube structure in which an arc tube holding a pair of electrodes and containing a gas such as a rare gas and a metal halide enclosed therein is disposed within an outer tube. The arc tube includes a light emitting portion and a pair of pinch seal portions which are made of quartz glass or the like. Discharge is carried out in an interior portion of the light emitting portion, while the two pinch seal portions are respectively disposed on the mutually opposite sides with the light emitting portion between them. The light emitting portion is shielded from an outside by the pinch seal portions. The light emitting portion is a portion where, when discharge is carried out, there is generated arc; and, it is formed larger in diameter than the pinch seal portions.

One-end portions of the pair of electrodes are respectively projected into the interior portion of the light emitting portion, while the other remaining portions thereof are respectively sealed to the pair of pinch seal portions. The other end portions of the pair of electrodes are welded to their corresponding molybdenum foils which are respectively sealed to their corresponding pinch seal portions.

In the discharge lamp, a given starting voltage is applied to the pair of electrodes held by the arc tube and discharge is carried out in the light emitting portion of the arc tube, thereby starting a turn-on operation of the discharge lamp.

In such discharge lamp, the arc tube is pinch sealed by the molybdenum foils in order to completely shield the arc tube from the outside.

Each of the molybdenum foils is formed in a very thin foil in order to minimize a stress which is generated due to a difference in coefficients of thermal expansion between it and the quarts glass of the pinch seal portions, while such difference depends on variations in temperature which are caused by repetitively turning on and off the discharge lamp.

However, when the discharge lamp is repetitively turned on and off in tens thousands times, a stress gradually causes the molybdenum foil and quartz glass to peel off from each other (to produce a crack), and, finally resulting in a lighting failure of the discharge lamp due to a leakage (that is, the discharge lamp comes to the end of its life).

As a method for preventing such discharge lamp lighting failure and thus for extending the life of the discharge lamp, two main methods may be considered: that is,

(1): a method for enhancing a degree of close contact between the molybdenum foil and the quartz glass.
(2): a method for separating the molybdenum foil from the light emitting portion, namely, increasing a length of the electrode.

However, in the (1) method for enhancing the degree of close contact between the molybdenum foil and quartz glass, since the close contact between the electrode and quartz glass is also enhanced, when the temperature is caused to vary due to the repetitive turn-on/off operations of the discharge lamp; and, such variations in the temperature give rise to a difference in the coefficients of thermal expansion between the electrode and pinch seal portion, a stress is generated as a result. This stress raises a possibility that a crack can be produced in the pinch seal portion existing around the electrode, whereby the lighting failure of the discharge lamp due to the leakage may be occurred.

Recently, due to environmental concerns, there has been increasing use of a discharge lamp of a type in which no mercury is enclosed into an arc tube. In such discharge lamp, since no mercury is enclosed in the arc tube, a voltage of the arc tube does not rise. As a result, a current of the arc tube becomes large. In order to correspond to such large arc tube current, outside diameters of the electrodes are set large. Due to this, the stress between the electrodes and pinch seal portions is intensified, thereby increasing the possibility that the crack can be generated in the pinch seal portions. Such crack can cause the leakage, thereby facilitating the occurrence of the lighting failure of the discharge lamp.

On the other hand, when the degree of close contact between the molybdenum foil and quarts glass is lowered, not only the life of the discharge lamp is shortened but also there can be generated a clearance between the electrode and quartz glass, which can also raise a possibility of causing the lighting failure of the discharge lamp due to the leakage.

Also, in the (2) method for separating the molybdenum foil from the light emitting portion, namely, increasing the length of the electrode, since the length of the close contact area between the electrode and quartz glass is increased, there is increased the stress which is generated between the electrode and pinch seal portion, and thus there is produced a crack in the pinch seal portion existing around the electrode. As a result of this, the leakage may be easy occurred, thereby facilitating the occurrence of the lighting failure of the discharge lamp due to the leakage.

In order to prevent the occurrence of the leakage due to the above crack, as a conventional discharge lamp, there is known a discharge lamp in which, in the other remaining portion of each electrode than such portion thereof as is projected into the light emitting portion, there is formed a concavo-convex part including a concave portion and a convex portion, and the electrodes are respectively welded to corresponding molybdenum foils in a state where given clearances are respectively formed between the electrodes and pinch seal portions (for example, see JP-A-2002-373622).

In the discharge lamp disclosed in JP-A-2002-373622, the above-mentioned concavo-convex parts are respectively formed in the electrodes, and impacts are given to the electrodes in a final stage in a step of sealing the arc tube to fly around a fused quarts glass existing in the concave portions, thereby simply and positively forming a clearance between the electrodes and pinch seal portions.

However, in the discharge lamp disclosed in JP-A-2002-373622, there is a possibility that the rare gas and metal halide (iodide) enclosed into the light emitting portion can move into the clearances between the electrodes and pinch seal portions. The rare gas and metal halide, which have moved into the clearances between the electrodes and pinch seal portions, are unable to contribute to the discharge that is carried out when turning on the discharge lamp, thereby raising a fear that the discharge lamp can fail to turn on.

Also, since there is formed the clearance between the electrode and pinch seal portion and the molybdenum foil is sealed to such portion of the pinch seal portion as continues with the clearance, due to the high pressure that is generated while the discharge lamp is lighted, an iodide is allowed to move from the clearance to the molybdenum foil in a gaseous state. When the gaseous iodide arrives at the molybdenum foil, owing to the fact that the iodide is set up when the discharge lamp is turned off, there is generated a stress that peels the molybdenum foil from the pinch seal portion to lower the degree of close contact between the pinch seal portion and molybdenum foil, whereby the leakage is occurred in the vicinity of the molybdenum foil sealed portion of the pinch seal portion (foil leakage). This gives rise to the lighting failure of the discharge lamp, resulting in the shortened life of the discharge lamp.

Further, in the discharge lamp disclosed in JP-A-2002-373622, since such portion of the electrode as includes the concavo-convex part is welded to the molybdenum foil, when, in the welding operation, the corner portion of the end portion of the molybdenum foil goes into the concave portion, there is a fear that the electrode can be welded while it is inclined with respect to the molybdenum foil. Such welding, when starting to turn on the discharge lamp, also raises a fear that discharge between the electrodes can be caused to fail.

### SUMMARY OF THE INVENTION

One or more embodiment of the present invention provide a vehicle discharge lamp which can restrict a generation of a crack to thereby prevent a leakage at an electrode or the like.

In accordance with one or more embodiments of the invention, a vehicle discharge lamp is provided with: an outer tube; an arc tube disposed within the outer tube and made of quartz glass, wherein no mercury is enclosed within the arc tube; and a pair of electrodes respectively disposed within the arc tube. The arc tube includes: a light emitting portion, wherein a rare gas and a metal halide are enclosed within the light emitting portion; and a pair of pinch seal portions respectively formed continuously with the light emitting portion on both sides of the light emitting portion, wherein molybdenum foils are respectively sealed in the pair of pinch seal portions. Each of the electrodes includes: a sealed portion sealed within corresponding one of the pinch seal portions; a projecting portion formed continuously with one end of the sealed portion and projecting into the light emitting portion; and a welding portion formed continuously with the other end of the sealed portion and welded to corresponding one of molybdenum foils. A concavo-convex part including a concave portion and a convex portion is formed on the sealed portion.

According to this structure, the concavo-convex part formed in the electrode is sealed within the pinch seal portion and the welding portion of the electrode, where no concavo-convex part is formed, is welded to the molybdenum foil.

According to this structure, since a stress to be generated when turning on and off the discharge lamp is dispersed by the concavo-convex parts to thereby make it hard for a large crack to occur, it is possible to prevent the leakage at the electrodes.

In the above structure, the concave portion may be formed in a spiral shape. According to this structure, it is easy to manufacture the electrode that includes a concavo-convex part.

In the above structure, the concave portion may include multiple concaves which are spaced from each other. According to this structure, a stress to be generated when turning on and off the discharge lamp can be easily dispersed by the recess and convex portions. This can provide an effect of restricting the generation of the crack.

In the above structure, a portion, where the concave portion and convex portion are continuously connected to each other, is formed in a curved surface shape. According to this structure, a concentration of stresses can be relieved and thus the generation of the crack can be restricted.

Other aspects and advantages of the invention will be apparent from the following description, the drawings and the claims.

### BRIEF DESCRIPTION OF THE DRAWINGS

FIG. 1 is a schematic section view of a vehicle discharge lamp of an exemplary embodiment of the invention.

FIG. 2 is enlarged side view, partially in section, of the discharge lamp.

FIG. 3 is an enlarged side view of an electrode and an enlarged section view thereof.

FIG. 4 is an enlarged side view of an electrode according to a first modification and an enlarged section view thereof.

FIG. 5 is an enlarged side view of an electrode according to a second modification and an enlarged section view thereof.

FIG. 6 is an enlarged side view of an electrode according to a third modification and an enlarged section view thereof.

FIG. 7 is an enlarged side view of an electrode according to a fourth modification and an enlarged section view thereof.

FIG. 8 is an enlarged side view of an electrode according to a fifth modification and an enlarged section view thereof.

FIG. 9 is an enlarged side view of an electrode according to a sixth modification and an enlarged section view thereof.

### DETAILED DESCRIPTION OF THE EXEMPLARY EMBODIMENTS

Detailed description of exemplary embodiments of the invention will be given with reference to the accompanying drawings. In the exemplary embodiments, the vehicle discharge lamp is mounted on a vehicle headlamp.

A vehicle headlamp 1 is mounted on right and left end portions of a front end portion of a vehicle body.

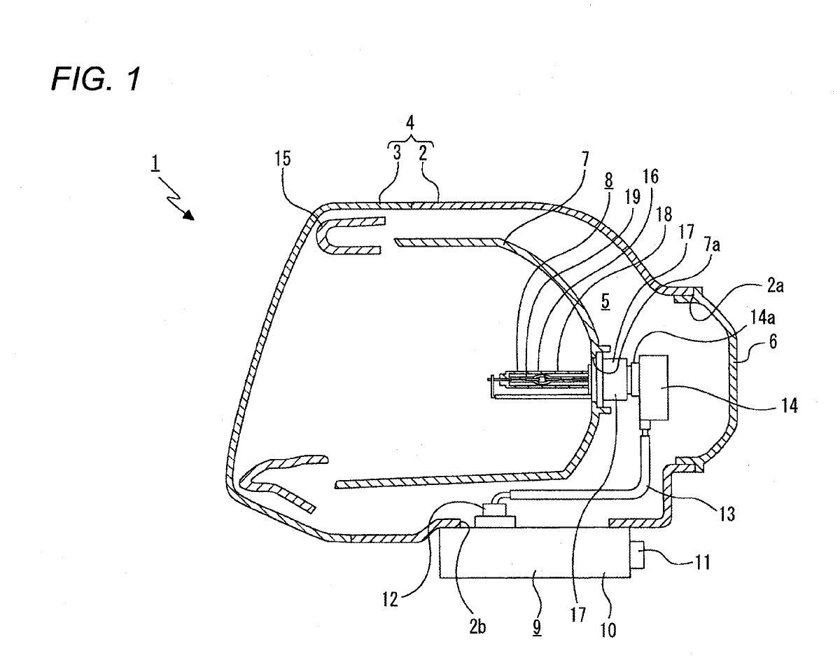

The vehicle headlamp 1, as shown in FIG. 1, includes a lamp housing 2 having a forwardly opened recessed portion and a cover 3 for covering the opened surface of the lamp housing 2. The lamp housing 2 and cover 3 cooperate together informing a lamp casing 4. The inner space of the lamp casing 4 is formed as a lamp chamber 5.

In a rear end portion of the lamp housing 2, there is formed an insertion hole 2a which penetrates back and forth through the rear end portion, while the insertion hole 2a is closed by a back cover 6. In a lower end portion of the lamp housing 2, there is formed a disposition hole 2b which penetrates vertically through the lower end portion.

Within the lamp chamber 5, a reflector 7 is supported by an optical axis adjusting mechanism (not shown) in such a manner that it can be inclined. In a rear end portion of the reflector 7, there is formed a mounting hole 7a which penetrates back and forth through the rear end portion.

On the mounting hole 7a of the reflector 7, there is mounted a discharge lamp (vehicle discharge lamp) 8.

On the disposition hole 2b of the lamp housing 2, there is mounted a discharge lamp lighting device 9. To form the discharge lamp lighting device 9, a lighting circuit (not shown) maybe stored within a case member 10. On the outer peripheral surface of the case member 10, there is provided an input side connector 11 and, on the upper surface of the case member 10, there is provided an output side connector 12. The input side connector 11 is connected to a power supply circuit (not shown).

The output side connector 12 is connected through a feed cable 13 to a starter device 14, while the connector 14a of the starter device 14 is connected to a socket (which will be discussed later) included in the discharge lamp 8.

To turn on the discharge lamp 8, the line voltage of the power supply circuit may be increased using the lighting circuit of the discharge lamp lighting device 9 and also may be d/c converted to thereby provide a lighting voltage (starting voltage) which is a high ac voltage; and, this lighting voltage may be applied through the feed cable 13 and starter device 14 to the discharge lamp 8 to thereby start discharge in the discharge lamp 8.

Within the lamp chamber 5, there is provided an extension 15 which is used to shield some of composing parts disposed in the lamp chamber 5. Within the lamp chamber 5, there is further provided a shade (not shown) which is used to shield a portion of the light that is emitted from the discharge lamp 8.

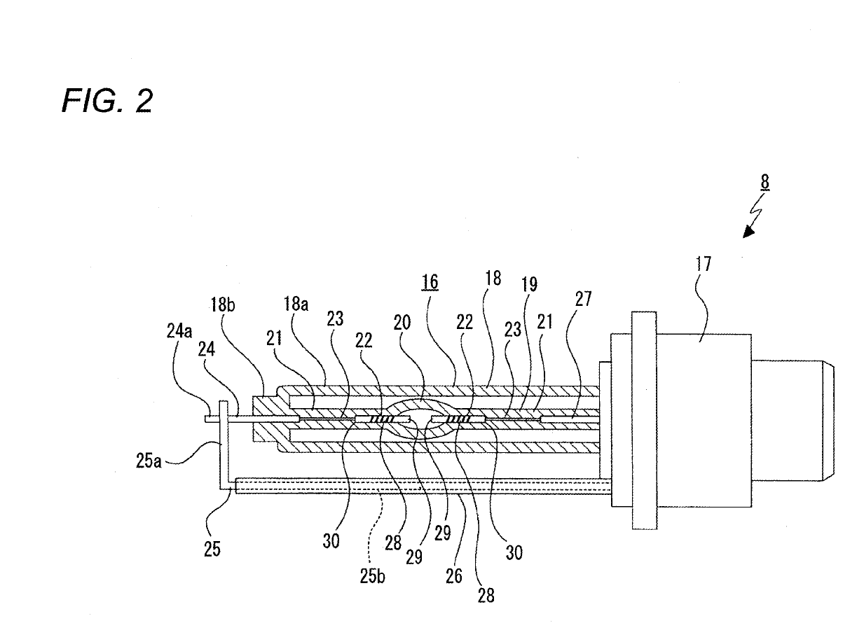

The discharge lamp 8 is structured by connecting a main body 16 to a socket 17 (see FIG. 2).

The main body 16 includes an outer tube 18 and an arc tube 19 disposed within the outer tube 18, while the outer tube 18 and arc tube 19 are made of quartz glass as an integral body.

The outer tube 18 includes a closing portion 18a for covering the arc tube 19 or the like and a holding portion 18b projected from the front end portion of the closing portion 18a.

The arc tube 19 includes, for example, a light emitting portion 20 having an inner space of 22 μl and an inside diameter of 2.6 mm, and two pinch seal portions 21, 21 respectively formed continuously with the front and rear ends of the light emitting portion 20. The pinch seal portions 21 and 21 are respectively formed to have substantially cylindrical shapes which extend forwardly and backwardly respectively, while the outside diameters of the pinch seal portions 21 are set smaller than the outside diameter of the light emitting portion 20.

Into the light emitting portion 20, there are enclosed 0.3 mg of metal halide, for example, NaI, ScI₃, ScBᵣ₃, InI, and ZnI₂ with the enclosure ratio (weight %) of 58; 12.8; 20; 0.2; and 9, and also, as a rare gas, Xe with the pressure of 15.5 pressures. Here, no mercury is enclosed in the light emitting portion 20.

The pinch seals 21 and 21 respectively hold thereon electrodes 22 and 22, each of which is formed to have a substantially round shaft shape long in the longitudinal direction. Each electrode 22 includes, for example, 0.1% of sodium oxide, and has a diameter of 0.3 mm to 0.4 mm and the whole length of 6 to 8 mm. The two electrodes 22 and 22 are held at intervals of, for example, 4.2 mm.

To the pinch seal portions 21 and 21, there are sealed molybdenum foils 23 and 23 each of which, for example, has a width of 1.5 mm and a thickness of 20 μm; and to the one-end portions of the molybdenum foils 23 and 23, there welded their associated electrodes 22 and 22.

To the front end portion of the molybdenum foil 23 that is situated on the front side, there is connected a first lead wire 24. The first lead wire 24 is projected forwardly from the front side pinch seal portion 21 of the arc tube 19, is penetrated through the holding portion 18b and is projected outwardly of the outer tube 18, while the thus outwardly projected portion of the first lead wire 24 is used as a connecting portion 24a. The connecting portion 24a of the first lead wire 24 is welded and connected to an external lead wire 25.

The external lead wire 25 includes a vertical portion 25a extending in the vertical direction and a horizontal portion 25b which is formed continuously with the lower end of the vertical portion 25a and extends in the longitudinal direction of the lead wire 25. The upper end portion of the vertical portion 25a is connected to the connecting portion 24a of the first lead wire 24, while the rear end portion of the horizontal portion 25b is connected to a first connecting terminal (not shown) which is provided in the socket 17.

The horizontal portion 25b of the external lead wire 25 is covered with an insulating sleeve 26. The insulating sleeve 26 is made of insulating material, for example, glass or ceramic.

To the rear end portion of the molybdenum foil 23 that is situated on the rear side, there is connected a second lead wire 27 which extends in the back-and-forth direction. The second lead wire 27 is projected backwardly from the rear side pinch seal portion 21 of the arc tube 19. The rear end portion of the second lead wire 27 is connected to a second connecting terminal (not shown) which is provided in the socket 17.

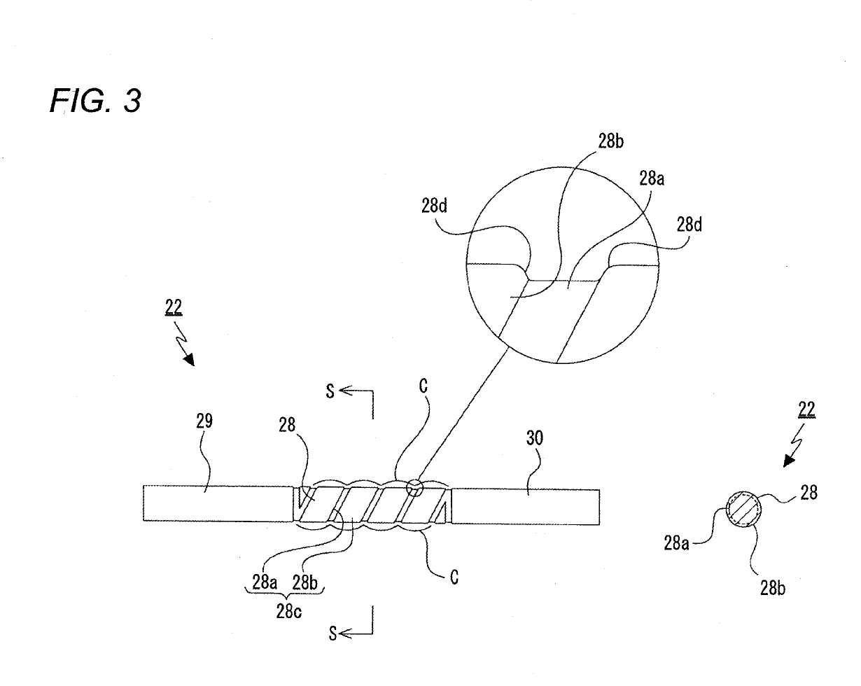

The electrode 22 is structured in the following manner. That is, as shown in FIG. 3, the portion of the electrode 22 in the longitudinal direction except for the two end side portions thereof is formed as a portion to be sealed (a sealed portion) 28; the portion of the electrode 22 in the longitudinal direction except for its one end side portion is formed as a projecting portion 29 which is projected into the light emitting portion 20; and, the portion of the electrode 22 in the longitudinal direction except for its other end side portion is formed as a welding portion 30 which is to be welded to the molybdenum foil 23.

Here, in FIG. 3 and its following figures, the side view of the electrode is shown on the left, while the section view taken along the section support lines S, S of the side view of the electrode is shown on the right. Also, in FIG. 3 and its following figures, the shape of a crack (micro crack) C supposed to be caused by a shape (a concavo-convex part which will be discussed later) formed in the electrode 22 is shown conceptually.

The sealed portion 28 is sealed to the pinch seal portion 21 of the ceramic arc tube 19. The sealed portion 28 includes a groove-shaped concave portion 28a arranged in a spiral manner. Thus, the other remaining portions of the sealed portion 28 than the concave portion 28a are formed as a convex portion 28b; and, the concave portion 28a and convex portion 28b cooperate together in constituting a concavo-convex part 28c.

Connecting portions 28d, 28d, - - - , where the concave portion 28a and convex portion 28b are connected together, are formed to have a curved surface shape (see the enlarged view of FIG. 3).

Referring to the structure of the concavo-convex part 28c, for example, a length of the area of the concavo-convex part 28c is set in the range of 1 to 5 mm, a height thereof is set in the range of 1 to 10% of the diameter of the electrode (that is, a height of the convex portion is set within a range of 1 to 10% with respect to a diameter of the projecting portion of the electrode, or a depth of the concave portion is set within a range of 1 to 10% with respect to a diameter of the projecting portion of the electrode), and the spacing between the recess and convex portions thereof is set in the range of 5 to 50% of the diameter of the electrode. To produce the concavo-convex part 28c, in a state where a round-shaft-shaped electrode rod is rotated around the axis thereof and is also moved in the axial direction thereof, a laser beam may be radiated onto such electrode rod to thereby be able to form the spiral-shaped concave portion 28a. Therefore, the concavo-convex part 28c including the spiral-shaped concave portion 28a can be produced easily.

The projecting portion 29 is projected into the light emitting portion 20 but is not sealed to the pinch seal portion 21.

The welding portion 30 is welded to the molybdenum foil 23 in a state where it is sealed to the pinch seal portion 21. The welding portion 30 has no concavo-convex part.

Since the electrode 22 is structured in the above-mentioned manner and also since the concavo-convex part 28c is formed in the sealed portion 28, a stress, which can be generated when the discharge lamp 8 is turned on and off, is dispersed by the concave portion 28a and convex portion 28b and thus a crack, which can be produced, is a so called micro crack: that is, a large crack is hard to be produced.

As described hereinabove, in the discharge lamp 8, since the electrode 22 includes the sealed portion 28, projecting portion 29 and welding portion 30 and also since the sealed portion 28 includes the concavo-convex part 28c, a stress to be produced in the lamp turn on and off operation is dispersed by the concavo-convex part 28c and thus a large crack is hard to be produced, which can prevent the generation of the leakage of the electrodes.

Also, since the sealed portion 28 is sealed by the pinch seal portion 21, a rare gas and metal halide enclosed into the light emitting portion 20 are prevented from moving into the pinch seal portion 21, which makes it possible to secure the proper turn-on state of the discharge lamp 8.

Further, since the metal halide is prevented from moving into the pinch seal portion 21, the metal halide can be prevented from generating a stress which can peel the molybdenum foil 23 from the pinch seal portion 21. This allows the molybdenum foil 23 to secure a high degree of close contact with respect to the pinch seal portion 21, thereby being able to prevent the sealed portion of the molybdenum foil 23 against leakage (foil leakage).

Moreover, in the discharge lamp 8, since the welding portion 30, that is, the portion of the electrode 22 where the concavo-convex part 28c is not formed, is welded to the molybdenum foil 23, the electrode 22 is welded to the molybdenum foil 23 in a state where it secures a high degree of close contact with respect to the molybdenum foil 23 and thus the electrode 22 is prevented from inclining with respect to the molybdenum foil 23, thereby being able to stabilize the lighting state of the discharge lamp 8.

In addition, since the portions 28d where the concave portions 28a and convex portions 28b of the electrodes 22 continue with each other are respectively formed to have a curved surface shape, the concentration of stresses can be relieved and thus the production of a crack can be restricted.

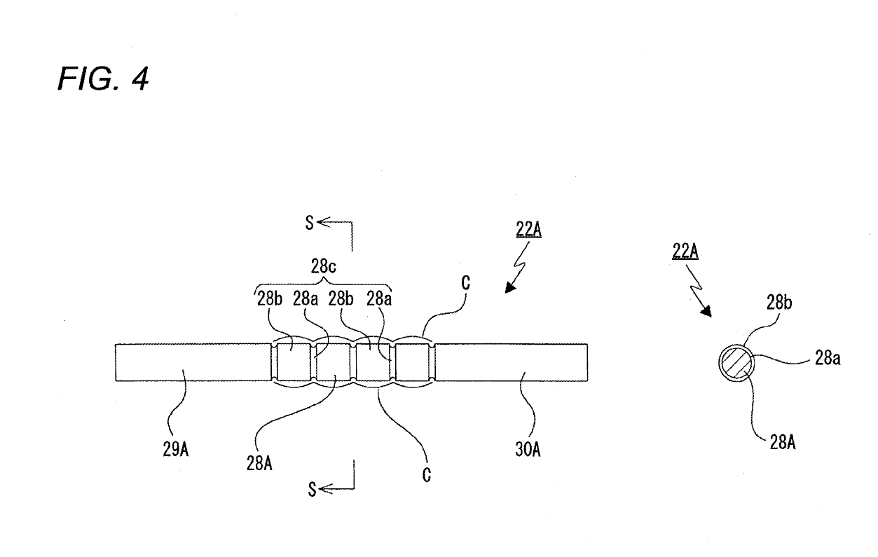

Now, description will be given below of modifications of the electrode (see FIGS. 4 to 9).

An electrode 22A according to a first modification, as shown in FIG. 4, includes a sealed portion 28A, a projecting portion 29A and a welding portion 30A. The sealed portion 28A includes groove-shaped concave portions 28a, 28a, - - - which respectively extend in the peripheral direction of the sealed portion 28A and are formed spaced from each other in the axial direction of the sealed portion 28A. Therefore, the other remaining portions of the sealed portion 28A than the concave portions 28a, 28a, - - - are formed as convex portions 28b, 28b, - - - ; and, the concave portions 28a, 28a, - - - and convex portions 28b, 28b, - - - cooperate together in constituting a concavo-convex part 28c.

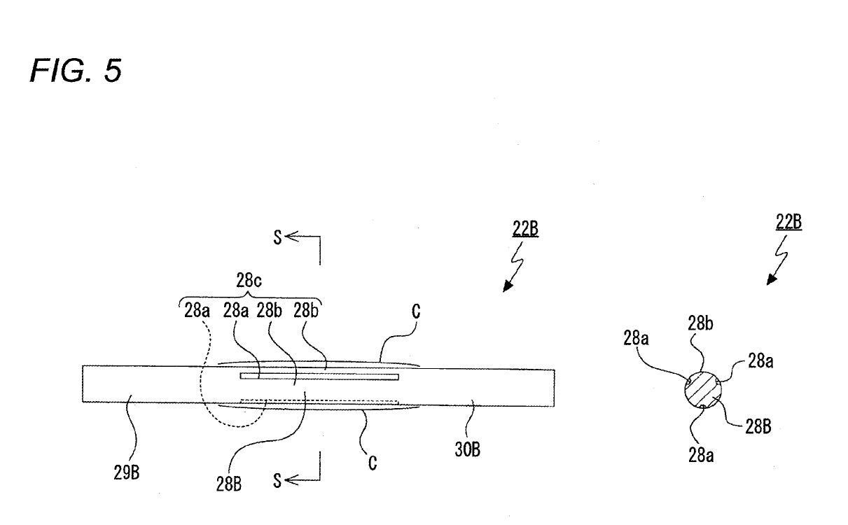

An electrode 22B according to a second modification, as shown in FIG. 5, includes a sealed portion 28B, a projecting portion 29B and a welding portion 30B. The sealed portion 28B includes groove-shaped concave portions 28a, 28a, - - - which respectively extend in the peripheral direction of the sealed portion 28B and are formed spaced from each other in the axial direction of the sealed portion 28B. Therefore, the other remaining portions of the sealed portion 28B than the concave portions 28a, 28a, - - - are formed as convex portions 28b, 28b, - - - ; and, the concave portions 28a, 28a, - - - and convex portions 28b, 28b, - - - cooperate together in constituting a concavo-convex part 28c.

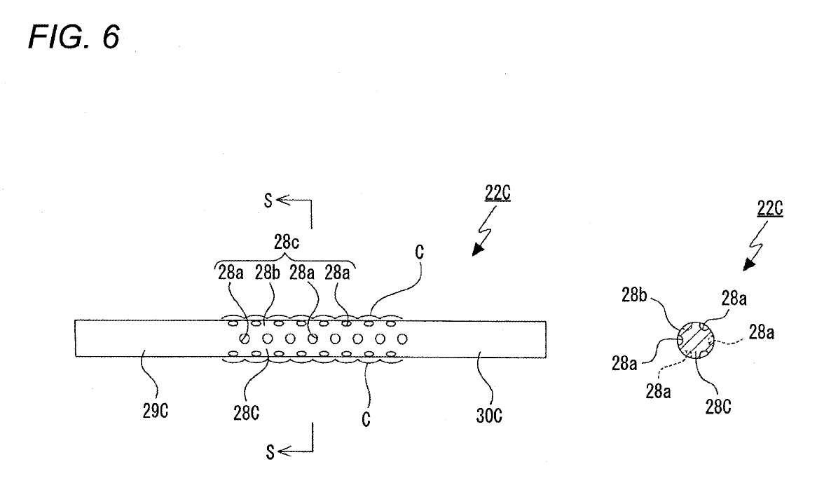

An electrode 22C according to a third modification, as shown in FIG. 6, includes a sealed portion 28C, a projecting portion 29C and a welding portion 30C. The sealed portion 28C includes hole-shaped concave portions 28a, 28a, - - - formed such that they are dotted. Therefore, the other remaining portions of the sealed portion 28C than the concave portions 28a, 28a, - - - are formed as convex portions 28b, 28b, - - - ; and, the concave portions 28a, 28a, - - - and convex portions 28b, 28b, - - - cooperate together in constituting a concavo-convex part 28c.

In the electrodes 22A, 22B and 22C respectively according to the first to third modifications, since the concave portions 28a, 28a, - - - are formed spaced from each other, a stress, which is generated in the turn-on and -off operation of the discharge lamp 8, can be easily dispersed by the concave portions 28a, 28a, - - - and convex portions 28b, 28b, - - - , thereby being able to enhance the effect of restricting the generation of a crack.

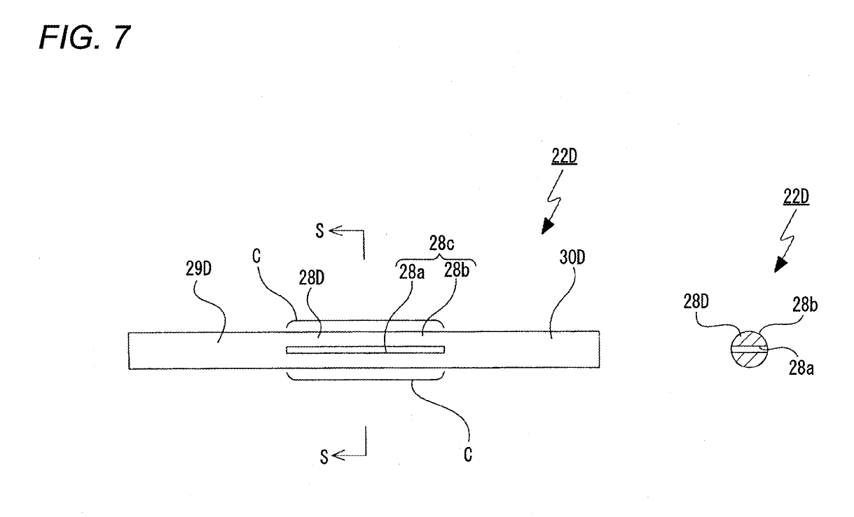

An electrode 22D according to a fourth modification, as shown in FIG. 7, includes a sealed portion 28D, a projecting portion 29D and a welding portion 30D. The sealed portion 28D includes a slit-shaped concave portion 28a which is formed to extend in the axial direction of the sealed portion 28D. The other remaining portion of the sealed portion 28D than the concave portion 28a is formed as a convex portion 28b; and, the concave portion 28a and convex portion 28b cooperate together in constituting a concavo-convex part 28c.

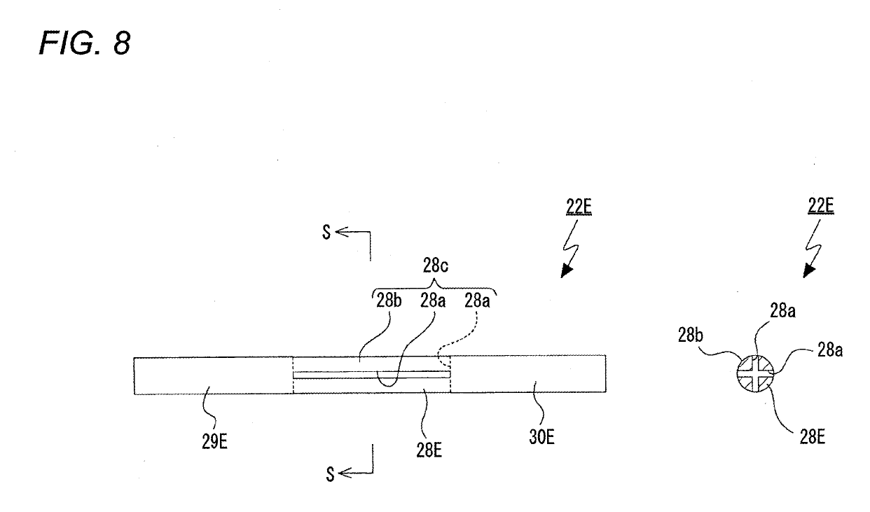

An electrode 22E according to a fifth modification, as shown in FIG. 8, includes a sealed portion 28E, a projecting portion 29E and a welding portion 30E. The sealed portion 28E includes slit-shaped concave portions 28a, 28a which are formed such that they extend in the axial direction of the sealed portion 28E and cross each other perpendicularly. The other remaining portion of the sealed portion 28E than the concave portions 28a, 28a is formed as a convex portion 28b; and, the concave portion 28a, 28a and convex portion 28b cooperate together in constituting a concavo-convex part 28c.

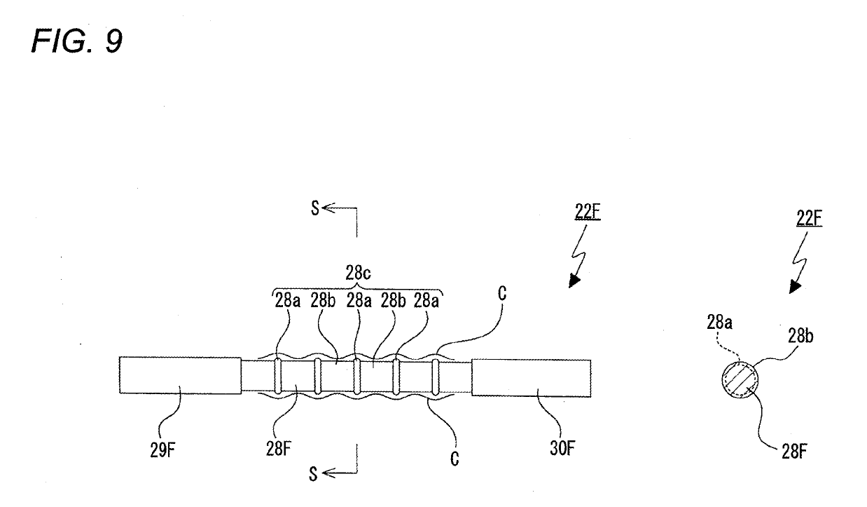

An electrode 22F according to a sixth modification is structured such that, in the electrode 22A according to the first modification, the concave portions and convex portions are formed in the mutually opposite positions. That is, as shown in FIG. 9, the electrode 22F includes a sealed portion 28F, a projecting portion 29F and a welding portion 30F. The sealed portion 28F includes convex portions 28b, 28b, - - - which are formed such that they respectively extend in the peripheral direction of the sealed portion 29F and are spaced from each other in the axial direction of the sealed portion 29F. Therefore, the other remaining portions of the sealed portion 28F than the convex portions 28b, 28b, - - - are respectively formed as concave portions 28a, 28a, - - - ; and, the convex portions 28b, 28b, - - - and concave portions 28a, 28a, - - - cooperate together in constituting a concavo-convex part 28c.

In the electrode 22F, for example, the convex portions 28b, 28b, - - - can be formed by cutting the portions of the electrode 22F that are formed as the concave portions 28a, 28a, - - - . Therefore, it is possible to increase the diameter of the projecting portion 29F which is the portion of the electrode 22F that is not cut. By increasing the diameter of the projecting portion 29F, the electrode 22F is able to cope with the load of a current value when the current value is set for a high value in order to secure a high tube voltage.

Here, in the above description, as an example of a structure in which the concave portion and convex portion are formed at their mutual opposite positions, there was illustrated the electrode 22F according to the sixth modification. However, in the second to fifth modifications as well, it is also possible to form an electrode having a structure in which the concave portion and convex portion are formed at their mutual opposite positions.

While description has been made in connection with a specific exemplary embodiment of the present invention and specific modifications thereof, it will be obvious to those skilled in the art that various changes and modification may be made therein without departing from the present invention. It is aimed, therefore, to cover in the appended claims all such changes and modifications falling within the true spirit and scope of the present invention.

### DESCRIPTION OF REFERENCE NUMERALS AND SIGNS

8: Discharge lamp (vehicle discharge lamp)
18: Outer tube
19: Arc tube
20: Light emitting portion
21: Pinch seal portion
22: Electrode
23: Molybdenum foil
28: Sealed portion
28a: Concave portion
28b: Convex portion
28c: Concavo-convex part
28d: Portion
29: Projecting portion
30: Welding portion
22A: Electrode
22B: Electrode
22C: Electrode
22D: Electrode
22E: Electrode
22F: Electrode

What is claimed is:

1. A vehicle discharge lamp comprising:
an outer tube;
an arc tube disposed within the outer tube and made of quartz glass, wherein no mercury is enclosed within the arc tube; and
a pair of electrodes respectively disposed within the arc tube,
wherein the arc tube includes:
a light emitting portion, wherein a rare gas and a metal halide are enclosed within the light emitting portion; and
a pair of pinch seal portions respectively formed continuously with the light emitting portion on both sides of the light emitting portion, wherein molybdenum foils are respectively sealed in the pair of pinch seal portions,
wherein each of the electrodes includes:
a sealed portion sealed within corresponding one of the pinch seal portions;
a projecting portion formed continuously with one end of the sealed portion and projecting into the light emitting portion; and
a welding portion formed continuously with the other end of the sealed portion and welded to corresponding one of the molybdenum foils, and
wherein a concavo-convex part including a concave portion and a convex portion is formed on the sealed portion.

2. The vehicle discharge lamp according to claim 1, wherein the concave portion is formed in a spiral shape.

3. The vehicle discharge lamp according to claim 1, wherein the concave portion includes multiple concaves which are spaced from each other.

4. The vehicle discharge lamp according to claim 1, wherein a portion, where the concave portion and convex portion are continuously connected to each other, is formed in a curved surface shape.

5. The vehicle discharge lamp according to claim 1, wherein a height of the convex portion is set within a range of 1 to 10% with respect to a diameter of the projecting portion of the electrode.

6. The vehicle discharge lamp according to claim 1, wherein a depth of the concave portion is set within a range of 1 to 10% with respect to a diameter of the projecting portion of the electrode.
